(19) United States
(12) Patent Application Publication
(10) Pub. No.: US 2025/0346461 A1
(43) Pub. Date: Nov. 13, 2025

(54) HYDRAULIC SYSTEM FOR PRESSURE SUPPLY OF A HYDRAULIC ACTUATOR

(71) Applicant: Liebherr-Werk Ehingen GmbH, Ehingen (DE)

(72) Inventors: Jörg GEBELE, Ulm (DE); Michael ENGST, Ehingen (DE)

(21) Appl. No.: 19/200,051

(22) Filed: May 6, 2025

(30) Foreign Application Priority Data
May 7, 2024 (DE) 10 2024 112 807.0

(51) Int. Cl. B66C 23/70; F15B 11/20; F15B 15/16

(52) U.S. Cl. CPC B66C 23/705; F15B 11/205; F15B 15/16; F15B 2211/7057

(57) ABSTRACT

The disclosure relates to a hydraulic system for pressure supply of a hydraulic actuator, comprising a double-acting hydraulic cylinder having two pressure chambers, and a rapid traverse device integrated into a valve unit and configured to hydraulically interconnect the two pressure chambers in a rapid traverse mode and hydraulically separate the two pressure chambers in a normal traverse mode. The valve unit connects to the pressure chambers via first and second connections and comprises a third connection for applying pressure via a hydraulic pump. A displaceably mounted shift piston separates the first and second connections in normal traverse position and connects them, separated from the third connection, in rapid traverse position. The valve unit integrates a preload device having a switchable preload element configured to separate the third connection from the second connection in a locking position, thereby locking the pressure chamber connected to the second connection towards the outside.

### CROSS REFERENCE TO RELATED APPLICATION

The present application claims priority to German Patent Application No. 10 2024 112 807.0 filed on May 7, 2024. The entire contents of the above-listed application are hereby incorporated by reference for all purposes.

### TECHNICAL FIELD

The present disclosure relates to a hydraulic system, and a valve unit and a work tool, in particular a mobile crane, comprising such a system.

### BACKGROUND

Piston-cylinder units comprise a cylinder housing and a piston that is displaceably mounted therein and comprises a piston rod. In the case of a double-acting piston-cylinder unit, pressure chambers are located on both sides of the piston, such that the piston rod is retracted or extended, depending on the pressure application of one or other pressure chamber. A pressure chamber through which a piston rod extends is also referred to as an annular chamber or annular space, owing to the annular piston surface, and a pressure chamber without a piston rod extending therethrough can be referred to as a piston chamber or piston space. Double-acting piston-cylinder units, the piston of which comprises a piston rod only on one side, are referred to as differential cylinders.

### SUMMARY

Telescopic cylinders of telescopic booms of known mobile cranes are a possible application for such piston-cylinder units. Such telescopic booms comprise an outer telescopic section and one or more inner telescopic sections displaceably mounted therein. In particular in the case of larger telescopic booms, often a single telescopic cylinder in the form of a hydraulic differential cylinder is used for telescoping the telescopic sections in and out, which hydraulic differential cylinder retracts and extends the inner telescopic sections in succession. For this purpose, a part of the telescopic cylinder, typically the piston rod, is connected to the base of the outer telescopic section, while the other part, typically the cylinder housing, retracts and extends relative to the outer telescopic section for applying pressure to the respective pressure chamber. The corresponding hydraulic lines are typically guided through the piston rod to the pressure chambers.

In order to be able to move the individual telescopic sections, the telescopic cylinder must be occasionally connected thereto. For this purpose, typically a locking device (known as a locking head) is provided on the telescopic cylinder, in particular on the piston rod-side end of the housing or on the collar, which locking device latches into the respective inner telescopic section, to be pushed out, via a plurality of spring-returned driving pins, such that the telescopic section extends together with the telescopic cylinder. The individual telescopic sections can furthermore be locked together in defined ejection positions via locking bolts spring-mounted on the telescopic sections. In order to be able to unlock or pull the locking bolts, they can typically be gripped by the locking device and moved into an unlocking position. For this purpose, the locking device typically comprises a spring-returned yoke, which can be brought into engagement with pulling moulds of rods of the locking bolts that protrude inwards into the telescopic sections.

Both the driving pins and the yoke are preloaded into their locking positions via spring elements and can be retracted into their unlocking positions by means of hydraulic energy, against the spring force of the return springs. The hydraulic supply required for this can take place via a pipe feedthrough integrated into the piston rod of the telescopic cylinder. Said pipe feedthrough can comprise two feedthrough pipes that are mounted so as to be displaceable inside one another, are sealed against one another, and are telescopic together with the cylinder. Upon extension of the telescopic cylinder, for example an inner feedthrough pipe also extends and also performs the telescopic cylinder movement. An outer feedthrough pipe having a larger diameter can be rigidly connected to the piston rod. At the cylinder-side end of the telescopic cylinder, the supply line is guided towards the outside, and outside of the cylinder back to the locking device.

A known problem in this arrangement is that when the bolting is open (i.e. in the unlocking position), in certain situations the pressure prevailing in the pipe feedthrough can lead to an undesired extension of the telescopic cylinder, i.e. in flat boom positions, in the case of low friction and/or in the case of a small load. In order to prevent this undesired movement, one of the pressure chambers (typically the ring side) can be preloaded with a pressure that counters the pressure in the pipe feedthrough and thus prevents extension. This preload should be switchable, since otherwise in the case of regular telescoping out and in unnecessarily high power losses would result at the preload. The control block required for this causes costs and weight, requires installation space, and corresponding line installations.

Furthermore, in the case of telescopic cylinders of this kind the necessary telescoping time, in particular in the case of a dead stroke, is an interfering factor. The aim is always to minimise the times for telescoping in and out. In this case, the dead stroke of the telescopic cylinder, which can in principle occur upon telescoping in and upon telescoping out, is noticed particularly significantly, because in this case no movement visible for the crane operator occurs (the telescopic cylinder is e.g. retracted inside the boom, in order to receive the next telescopic section). In this case, a difference occurs on account of the difference between the piston and annular surface: the extension of the telescopic cylinder is significantly slower than the retraction of the telescopic cylinder, since it takes longer, with the same oil flow, to fill the larger piston space.

In order to reduce the times for telescoping out, the speed of the telescopic cylinder piston can be increased. Higher speeds require a higher inflow of oil to the piston side. This can be achieved with a larger pump or, if possible, with an increase in the drive speed. Both options have the disadvantages of increased costs and/or a higher weight, as well as increased noise and greater flow losses. A further possibility is to reduce the size of the piston surface, which, however, leads to payload losses if the pressure cannot be further increased at the same time.

A further solution consists in connecting the ring and piston sides via a rapid traverse circuit upon extension of the cylinder. Thus, the outflowing ring-side oil is returned directly to the piston side for extension, which correspondingly increases the oil flow to the piston side and thus the speed upon telescoping out. The available cylinder force upon extension is reduced in the ratio of piston surface to rod cross-sectional area, which, however, generally does not limit the telescopic process or only in the high payload range of the telescopic payloads.

The object of the present disclosure is that of preventing the mentioned disadvantages of the prior art and developing said prior art in an advantageous manner. This is intended to be achieved in particular with a compact and weight-saving device.

This object is achieved by a hydraulic system and a valve unit having the features as described herein.

According thereto, a hydraulic system for pressure supply of a hydraulic actuator is proposed. The hydraulic actuator can be an actuator of a locking device described at the outset (e.g. at least one actuator for actuating a pulling yoke and/or at least one actuator for unlocking driving pins). However, the disclosure is not limited to this use. The actuator can be part of the hydraulic system. The hydraulic system comprises a double-acting hydraulic cylinder having a first and a second pressure chamber, to which pressure can be applied via a hydraulic pump, in order to move a piston of the hydraulic cylinder. The hydraulic cylinder can be a telescopic cylinder.

The hydraulic system further comprises a rapid traverse device which is configured to hydraulically interconnect the two pressure chambers in a rapid traverse mode, such that hydraulic fluid displaced out of one pressure chamber can flow into the other pressure chamber. As a result, the filling of a pressure chamber that increases in size in the case of the retraction or extension movement of the hydraulic cylinder can be accelerated. The rapid traverse device is furthermore configured to hydraulically separate the two pressure chambers from one another in a normal traverse mode, such that hydraulic fluid displaced out of one pressure chamber cannot flow into the other pressure chamber (but rather for example flows away into a hydraulic tank).

According to the disclosure, the hydraulic system comprises a valve unit in which the rapid traverse device is integrated. The valve unit has a first connection and a second connection, which are in each case connected to one of the mentioned pressure chambers of the hydraulic cylinder. It is noted that in the present case reference to connections means hydraulic connections. The valve unit further has a third connection to which pressure is applied via the hydraulic pump. Optionally, the third connection can be selectively connected to the hydraulic pump or to a hydraulic tank via a control valve.

The valve unit comprises a displaceably mounted shift piston which hydraulically separates the first and second connections from one another in a normal traverse position, while in a rapid traverse position the shift piston hydraulically interconnects the first and second connections and separates these simultaneously from the third connection. In the rapid traverse position, hydraulic fluid displaced out of one pressure chamber can flow via the valve unit into the other pressure chamber, as described above.

According to the disclosure, a preload means is additionally integrated into the valve unit, wherein the preload means comprises a switchable preload element which is configured to separate the third connection from the second connection in a locking position and thereby to lock the pressure chamber connected to the second connection (for example the annular chamber of a telescopic cylinder) towards the outside. The locking prevents a pressure, building up in the hydraulic cylinder, leading to a retraction or extension of the hydraulic cylinder. This may be necessary e.g. in the case of a telescopic cylinder having a pipe feedthrough, in order to prevent an undesired extension of the piston rod on account of a pressure buildup in the pipe feedthrough (see above). Optionally, in the locking position, the preload element separates the third connection from the first connection and from the second connection.

In the normal traverse position, the shift piston may allow for a fluidic connection between the second and third connections. However, these can be separated from one another in the locking position by the preload element.

A more compact, more cost-effective and more weight-saving structure is achieved by the integration of the rapid traverse and preload functions into a common valve unit. Furthermore, there is the option of configuring the valve unit as a valve cartridge and integrating it directly into the hydraulic cylinder.

In a possible embodiment, it is provided that the valve unit comprises an actuation unit, by means of which the shift piston is movable between the normal traverse and the rapid traverse position. The actuation unit can be mechanically, hydraulically or electrically controllable, wherein the latter may be preferred. The actuation unit may be a solenoid valve. A valve piston of the solenoid valve can be arranged coaxially to the shift piston. The shift piston may be preloaded into the normal traverse position by a first preload device which may comprise or be a spring, and is movable into the rapid traverse position by the actuation unit. Thus, when the actuation unit is deactivated (e.g. the mentioned solenoid valve is not energised) the valve unit is in the normal traverse mode.

In a further possible embodiment it is provided that the preload element is configured as a sleeve which surrounds the shift piston and is mounted so as to be displaceable relative thereto. This results in a particularly compact structure of the valve unit. The sleeve may be arranged in the region of the third connection.

The valve unit can comprise mechanical stops which limit an axial movement of the preload element. Alternatively or in addition, a mechanical stop for the preload element can be arranged/formed on the shift piston.

In a further possible embodiment it is provided that the shift piston has a channel that extends along its displacement direction, i.e. axially. Said channel can extend inside in the shift piston and may extend coaxially. The channel is guided towards the outside (this can take place perpendicularly or at an acute angle to the shift piston axis) in the region of the sleeve (preload element), and leads into an annular chamber formed between the shift piston and the sleeve. The sleeve can comprise a control surface that limits the annular chamber (e.g. an end-face annular control surface) to which pressure can be applied via the channel, in order to move the sleeve. The channel can comprise one or more throttles.

Optionally, an opening of the channel is arranged, in the shift piston, in the region of the first connection, such that the annular chamber is hydraulically connected to the first connection, in particular irrespective of the position of the shift piston. The channel can lead, on the opposite side of the shift piston, into a chamber that is in hydraulic connection with the actuation unit.

In a further possible embodiment it is provided that the preload element is preloaded into the locking position by a second preload device, wherein this can comprise or be a second spring which is supported on the preload element. The preload element can be moved, by pressure application of the first or of the third connection in normal traverse mode, into an open position in which the second and third connections are hydraulically interconnected. As a result, the preload may be “deactivated” when pressure is purposely applied to one of the pressure chambers for retracting or extending the hydraulic cylinder, such that the retraction or extension does not have to take place against the preload force. In the absence of a pressure at the first or third connection, the pressure chamber connected to the second connection is blocked.

In a further possible embodiment it is provided that the valve unit comprises a non-return valve which is arranged between the first and second connections and is configured, in the rapid traverse position of the shift piston, to release a flow of hydraulic fluid from the second to the first connection and to block a flow of hydraulic fluid from the first to the second connection. If the valve unit is configured as a valve cartridge, the non-return valve can be integrated into the cartridge or can be arranged between the cartridge and a cartridge housing that receives the cartridge. The non-return valve means that in the rapid traverse mode hydraulic fluid can flow from one pressure chamber into the other pressure chamber only in one direction (e.g. upon extension of the hydraulic cylinder, in which a piston chamber that is larger than an annular chamber fills).

The non-return valve can comprise a valve body and annularly surrounds the shift piston and is mounted so as to be displaceable relative thereto, which results in a particularly compact structure. An end face of the valve body can comprise at least one chamfered control surface, the application of pressure to which from the second connection leads to opening of the non-return valve.

In a further possible embodiment it is provided that the hydraulic system comprises a control valve for retraction and extension of the hydraulic cylinder. Depending on the switching position of the control valve, the first or the second pressure chamber of the hydraulic cylinder is filled with hydraulic fluid. The control valve comprises a first intake that is connected to the hydraulic pump, optionally a second intake that is connected to a hydraulic tank, and a first outlet connected to a first pressure chamber of the hydraulic cylinder and a second outlet connected to a second pressure chamber of the hydraulic cylinder. Optionally, depending on the switching position, the respective outlets and thus the pressure chambers are connected to the hydraulic pump or the hydraulic tank.

For example, one of the outlets of the control valve may be connected to the third connection of the valve unit, such that for example the pressure chamber connected to the second connection can be filled with hydraulic fluid via said connection in normal traverse mode (or optionally vice versa, hydraulic fluid can flow out of the pressure chamber, via the third connection, into a hydraulic tank). Alternatively or in addition, one of the outlets of the control valve can be connected to the first connection of the valve unit.

Optionally, the valve unit has a fourth connection which can possibly be permanently hydraulically connected to the first connection (irrespective of the switching position of the shift piston), wherein one of the outlets of the control valve is connected to the third connection and the other outlet of the control valve is connected to the fourth connection. Hydraulic fluid can flow via the fourth connection into the pressure chamber connected to the first connection, and vice versa (in this case this can be e.g. a piston chamber of the hydraulic cylinder).

The control valve can be controllable via one, optionally two, pre-control valves. The control valve can be configured as a main valve.

It is conceivable for the hydraulic system to comprise a pressure balance which ensures a constant hydraulic fluid flow via the control valve, in that it keeps the difference between the pressures at one of the two outlets of the control valve and the hydraulic pump constant.

In a further possible embodiment it is provided that the hydraulic system comprises a control unit, by means of which an actuation unit moving the shift piston is electrically controllable for switching between rapid traverse and normal traverse mode. The actuation unit can be configured as described above. The control unit may be configured to determine a load of the hydraulic cylinder depending on at least one pressure measurement in the hydraulic system, and to compare said load with at least one stored characteristic value. For pressure measurement, the hydraulic system can comprise at least one pressure sensor. Optionally, the pressures prevailing in the pressure chambers are detected by two pressure sensors, and a current load is determined therefrom. The at least one characteristic value may be a threshold value stored in a family of characteristics and/or in a payload table. Alternatively, it is conceivable for the characteristic value to be calculated by the control unit.

The maximum payload that can be moved using the hydraulic cylinder can be smaller in rapid traverse mode than in normal traverse mode. In order that a maximum payload is not exceeded on account of switching into the rapid traverse mode, in one embodiment, the control unit is configured to determine a load resulting in the future due to switching, before the switching from rapid traverse to normal traverse mode, or vice versa, and to compare this load with at least one stored characteristic value, and to decide, on the basis of the comparison, whether or not switching can take place

In the case of a mobile crane with a telescopic cylinder, the crane operator would have to make this decision with the aid of payload tables, but would be significantly distracted from the crane operation by looking at the payload tables. Therefore, the switching between rapid and normal traverse may take place automatically by the control unit, which decides by prior calculation of the operating pressures in the piston and in the ring side, in each case before or after switching between rapid and normal traverse mode, whether switching is actually possible or not, and accordingly switches or not. This unburdens the crane operator, who can concentrate on the handling of the load and in this case nonetheless always achieves the quickest telescoping time in the respective situation.

In a further possible embodiment it is provided that the hydraulic system comprises a lowering brake valve which is arranged between the valve unit and one of the pressure chambers. In the case of a telescopic cylinder the lowering brake valve is in particular arranged between the piston chamber and the valve unit (in particular the first connection of the valve unit). In a first switching position the lowering brake valve blocks a return flow of hydraulic fluid out of the pressure chamber (e.g. blocking a retraction of the hydraulic cylinder), but optionally, vice versa, releases a flow of hydraulic fluid into the pressure chamber (e.g. allowing an extension of the hydraulic cylinder), in particular by means of an integrated non-return valve. The lowering brake valve has a second switching position in which a return flow of hydraulic fluid out of the pressure chamber is permitted (e.g. controlled retraction of the hydraulic cylinder under external load). For this purpose, the lowering brake valve can comprise a throttle which reduces the through-flow in the second switching position.

In a further possible embodiment it is provided that the hydraulic cylinder comprises a piston and a piston rod with a pipe feedthrough. The latter can be configured as described in the introduction with respect to the prior art. The pressure supply of the at least one hydraulic actuator takes place via the pipe feedthrough (e.g. the locking device of a telescopic cylinder). The piston rod is optionally guided on one side out of a cylinder housing of the hydraulic cylinder (differential cylinder), wherein the hydraulic cylinder comprises an annular chamber, which is optionally connected to the second connection of the valve unit, and a piston chamber, which is optionally connected to the first connection of the valve unit.

In the locking position, the preload means integrated into the valve unit may prevent an undesired extension of the piston rod (=reduction in size of the annular chamber) taking place in the event of actuation of an actuator supplied via the pipe feedthrough, owing to a pressure buildup in the pipe feedthrough, in that a return flow out of the annular chamber via the valve unit is blocked. If pressure is purposely applied to one of the pressure chambers, via a hydraulic pump, for retraction or extension, then the preload means may open automatically.

In a further possible embodiment it is provided that the hydraulic cylinder is a telescopic cylinder and the hydraulic system comprises a locking device connected to the telescopic cylinder for reversibly locking the telescopic cylinder to a telescopic section and/or for reversibly locking two telescopic sections of a telescopic boom, wherein at least one hydraulic actuator of the locking device can be supplied with pressure via the hydraulic system.

In a further possible embodiment, it is provided that the components of the rapid traverse device and of the preload means are arranged in a common housing of the valve unit. This results in a compact structure. Alternatively or in addition, the valve unit can be configured as a valve cartridge and be arranged inside a cylinder housing of the hydraulic cylinder.

In a further possible embodiment it is provided that the control piston comprises at least one control notch in order to prevent a pressure release shock in the case of switching between a normal and rapid traverse position of the shift piston, or to at least reduce this (delayed pressure reduction). The at least one control notch can be configured as an axially milled-in groove and/or as a radially applied bevel (a combination of a plurality of such grooves is conceivable). The at least one control notch can be formed on a portion of the control piston which is formed with an edge of a valve housing or a sleeve receiving the control piston, and by which the control piston is contacted in a sealing manner in the rapid traverse position. An abrupt increase in the flow cross-section upon transition into the normal traverse position is reduced by the at least one control notch, and as a result a sudden pressure reduction is prevented.

In a further possible embodiment, it is provided that the hydraulic pump is configured as a variable displacement pump. The variable displacement pump can be equipped with an electro-proportional controller, in order to implement a load sensing system.

The disclosure further relates to a valve unit having an integrated rapid traverse device and integrated preload means of the hydraulic system according to the disclosure. The valve unit according to the disclosure thus comprises all the features of the device described with respect to the hydraulic system, and has the same properties or allows the same advantages. A repeated description is therefore omitted. In particular, the valve unit according to the disclosure can be configured according to any of the embodiments described above in this respect.

The disclosure further relates to a work tool, for example a mobile crane, comprising a hydraulic system according to the disclosure. This may control an actuator of the work tool for performing a work function.

In a possible embodiment, it is provided that the work tool is configured as a mobile crane having a telescopic boom, wherein the telescopic boom comprises an outer telescopic section, at least one inner telescopic section that is displaceably mounted therein, a hydraulic telescopic cylinder for retracting and extending the at least one inner telescopic section, and a locking device that is connected to the telescopic cylinder for reversibly locking the telescopic cylinder to an inner telescopic section and/or for locking two telescopic sections together. At least one actuator of the locking device can be supplied with pressure or controlled via the hydraulic system according to the disclosure. The actuators can be at least one actuator for actuating a pulling yoke, and/or at least one actuator for actuating a driving pin.

### BRIEF DESCRIPTION OF THE FIGURES

Further features, details and advantages of the disclosure will emerge from the embodiments explained in the following with reference to the figures, in which:

FIG. 1: is a schematic view of the hydraulic system according to the disclosure according to one embodiment; and

FIGS. 2-5: are longitudinal sectional views of an embodiment of the valve unit according to the disclosure in different switching positions.

### DETAILED DESCRIPTION

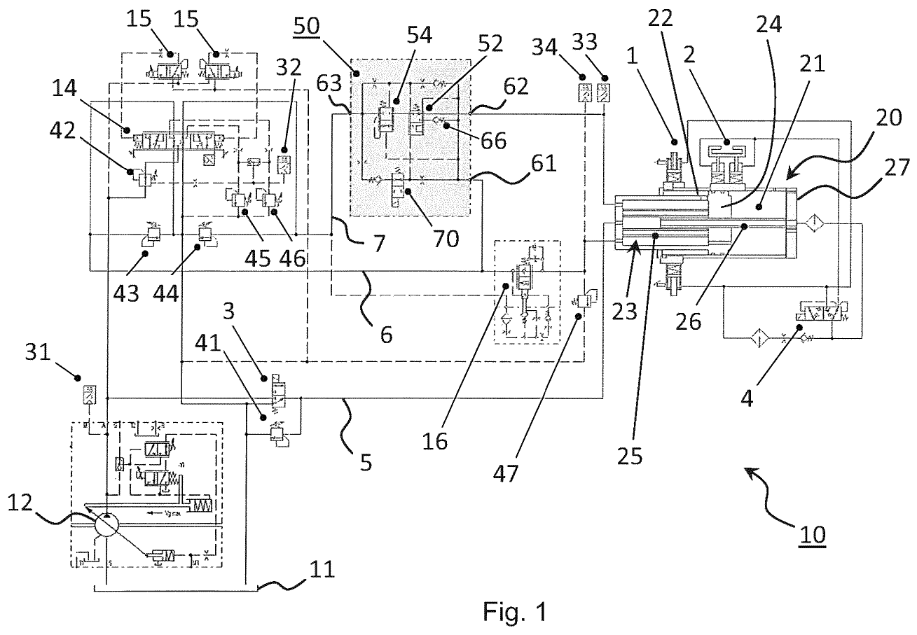

FIG. 1 shows an embodiment of the hydraulic system according to the disclosure. The hydraulic system 10 comprises a double-acting hydraulic cylinder 20 which, in the present embodiment, is configured as a telescopic cylinder for a telescopic boom having a locking device attached on the outside on the cylinder housing 27. However, the following statements and the mode of operation of the hydraulic system according to the disclosure are not limited to this application.

The locking device serves the purpose described at the outset and comprises spring-returned driving pins which can be actuated (retracted) via first hydraulic actuators 1, and a spring-returned pulling yoke which can be actuated via a second hydraulic actuator 2. The hydraulic supply and control of the actuators 1, 2 takes place via a hydraulic pump 12 of the hydraulic system 10 and via the valves 3 and 4. The valve 3 is connected to the valve 4 via the supply line 5 and connects said valve, depending on the switching position, to the hydraulic pump 12 or to a hydraulic tank 11.

The hydraulic cylinder 20 comprises a piston 24 and a piston rod 23 that is guided out of the cylinder housing 27 on one side, and is thus a differential cylinder. The piston rod 23 has a hydraulic pipe feedthrough 25, 26 which is connected to the supply line 5 and via which the hydraulic supply of the actuators 1, 2 takes place. The pipe feedthrough comprises two feedthrough pipes 25, 26 that are mounted so as to be displaceable inside one another, are sealed against one another, and are telescopic together with the hydraulic cylinder 20. An inner feedthrough pipe 26 can be connected to the cylinder housing 27 and extend therewith, while an outer feedthrough pipe 25 can be rigidly connected to the piston rod 23.

The hydraulic cylinder 20 has a piston-side pressure chamber or piston chamber 21 (first pressure chamber) and a piston rod-side pressure chamber or annular chamber 22 (second pressure chamber). For retracting the hydraulic cylinder 20 or for telescoping in, pressure is applied to the annular chamber 22 via the hydraulic pump 12. For extending the hydraulic cylinder 20 (telescoping out), pressure is applied to the piston chamber 21 via the hydraulic pump 12. The pressure application of the respective pressure chambers 21, 22 takes place via a control valve 14—in the present case a main valve actuated via two pre-control valves 15.

The intakes of the control valve 14 are connected to the hydraulic pump 12 and the hydraulic tank 11, while the outlets of the control valve 14 are connected via one supply line 6 to the piston chamber 21 and via a further supply line 7 to the annular chamber 22. The piston rod 23 can comprise connections which connect the supply lines 6, 7 via inner cavities or channels to the respective pressure chambers 21, 22 (cf. FIG. 1).

The hydraulic pump 12 can comprise an electro-proportional controller, in order to implement a load sensing system, to which the control valve 14 belongs. The hydraulic system 10 can comprise a pressure balance which ensures a constant oil flow via the control valve 14, in that it keeps the difference between the pressures at the intake and outlet of the control valve 14 constant. In FIG. 1, the pressure limiting valve 42 is part of the optionally provided pressure balance.

Pressure limiting valve 45, 46 can be provided which limit the load sensing pressure (cf. FIG. 1). Optionally, two pressure limiting valves 43, 44 connected to the supply lines 6, 7 limit the pressure in the hydraulic cylinder 20. A pressure limiting valve 41 can be connected in parallel with the valve 3.

The hydraulic system 10 can comprise one or more pressure sensors or pressure transducers. Thus, for example a pressure sensor 32 provided on the pressure balance and a pressure sensor 31 connected to the pump outlet can allow for control of the hydraulic pump 12 on the basis of the difference between the measured pressure values of the pressure sensors 31 and 32, which difference serves as the control variable.

Optionally, in each case one pressure sensor 33, 34 is connected to one of the pressure chambers 21, 22 or to one supply line 6, 7 leading to the respective pressure chamber 21, 22, in order for example to be able to determine a current load of the hydraulic cylinder 20 on the basis of the acquired pressures (see below).

The hydraulic system 10 may have a lowering brake valve 16 which makes it possible to retract or stop the hydraulic cylinder 20 in a controlled manner, even under a load. This is important for example for telescopic cylinders. In the switching position shown in FIG. 1, a non-return valve of the lowering brake valve 16 prevents a return flow of hydraulic oil out of the piston chamber 21, while filling of the piston chamber 21 for extension is possible. In a second switching position, a braked and controlled retraction of the hydraulic cylinder 20 is made possible via an integrated throttle. A pressure limiting valve 47 can be connected in parallel with the lowering brake valve 16, in order to prevent an excess pressure from heating of the hydraulic oil when the lowering brake valve 16 is closed, e.g. by solar radiation.

The components described above (load sensing system, pressure limiting valves, pressure balance, lowering brake valve, pressure sensors, etc.) are optional and can be provided in any combination, in the hydraulic system 10.

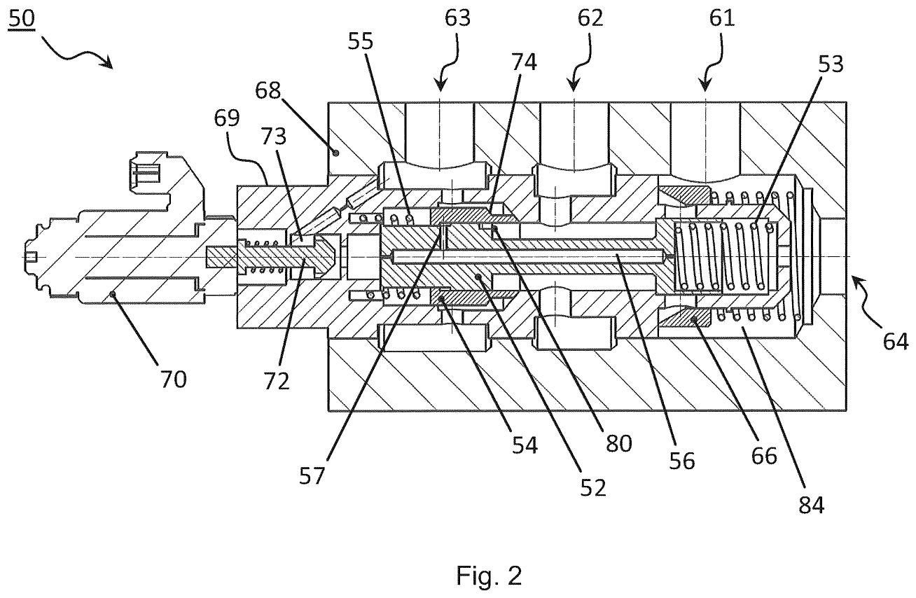

According to the disclosure, the hydraulic system comprises a valve unit 50 which integrates a rapid traverse function and a preload function in a common unit and will be explained in the following with reference to an embodiment shown in FIGS. 2-5. The essential components of the valve unit 50 are also shown schematically in FIG. 1 as valve components.

The valve unit 50 comprises on the one hand a rapid traverse device (represented in FIG. 1 by the components 52, 66 and 70), which makes it possible to interconnect the two pressure chambers 21, 22 upon actuation. Thus, in the case of extension of the hydraulic cylinder 20, the hydraulic oil flowing out of the annular chamber 22 is returned directly to the piston chamber 21, which correspondingly significantly increases the oil flow to the piston side and thus the speed upon extension or telescoping out. In the embodiment of FIG. 1, the valve unit 50 is arranged after the lowering brake valve 16, proceeding from the hydraulic cylinder 20, such that said lowering brake valve assumes only the safety function (blocking the piston chamber 21).

The preload means (represented in FIG. 1 by the component 54) is provided for preventing an undesired extension of the telescopic cylinder 20 when the actuators 1, 2 are actuated (i.e. when the bolting is unlocked). In this case, the operating pressure of the bolting in the pipe feedthrough 25, 26 acts in such a way that the telescopic cylinder 20 extends in an undesired manner in certain situations, because the inner feedthrough pipe 26 is pushed out by the oil pressure acting in the two feedthrough pipes 25, 26 and thus the telescopic cylinder 20 also extends. In this case, hydraulic oil is displaced out of the annular chamber 22. This is prevented by a preload element 54 of the preload means.

The valve unit 50 has a first connection 61 which is connected to the piston chamber 21. In FIG. 1, the first connection 61 is connected to the supply line 6 still in front of the lowering brake valve 16. The valve unit 50 has a second connection 62 which is connected to the annular chamber 22, and a third connection 63 which is connected to the outlets of the control valve 14.

In the embodiment of FIG. 1, the first connection 61 communicates with the other connection of the control valve 14 and thus, via the lowering brake valve 16, with the piston chamber 21. In the embodiment of FIGS. 2-5, which show a longitudinal section through the valve unit 50, an additional fourth connection 64 is provided, which is connected to the control valve 14, wherein the first connection 61 is connected to the piston chamber 21. Since, however, the first and fourth connections 61, 64 are hydraulically interconnected in each switching position, functionally the same situation as in FIG. 1 results.

FIG. 2 shows the valve unit 50 in the unactuated state, i.e. the hydraulic cylinder 20 is not controlled via the hydraulic pump 12 and pressure is not applied to any of the pressure chambers 21, 22.

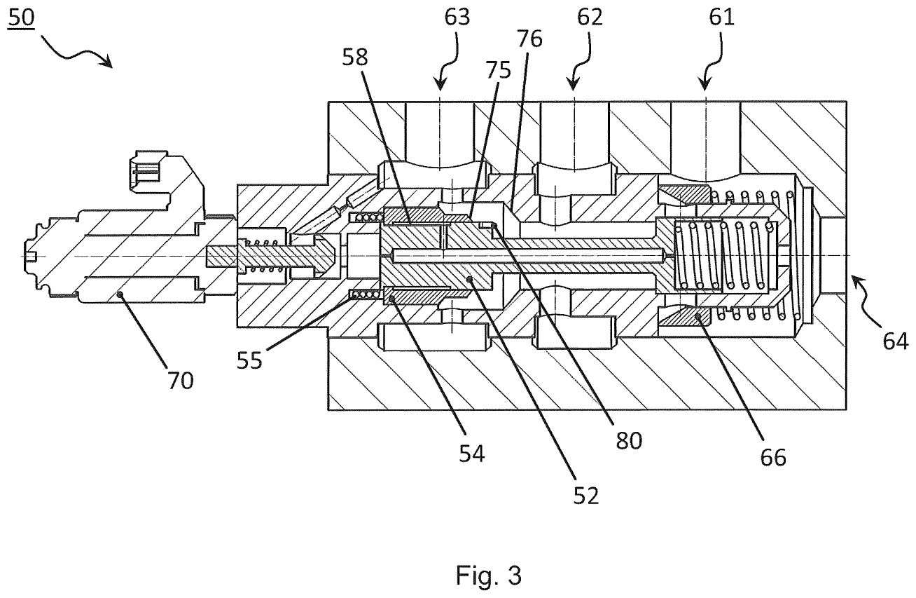

The valve unit 50 has a valve housing 68 which comprises the mentioned connections 61-64. A control piston 52 is mounted in an axially displaceable manner within the valve housing 68. The control piston 52 can be arranged inside a sleeve 69, which is introduced into a recess of the valve housing 68 and comprises corresponding openings which correspond to the connections 61-64. For the sake of simplicity, in the following reference will be made only to the valve housing 68, although this can also mean the sleeve 69. The control piston 52 is preloaded into the left-hand position (cf. FIG. 2) by a first spring 53 (=first preload device). In this case, a control edge 51 of the control piston 52 (see FIG. 3) in interaction with a corresponding step of the valve housing 68/69 closes the connection between the first connection 61 and the second and third connections 62, 63.

The valve unit 50 further comprises a preload element 54 which, in the embodiment shown, is configured as a sleeve 54 that is mounted so as to be displaceable relative to the control piston 52 and surrounds it annularly. The preload element 54 is preloaded by a second spring 55 (=second preload device) into the right-hand position (cf. FIG. 2), in which a valve surface 75 of the sleeve 54 interacts with a valve seat 76 (see FIG. 3) formed in the valve housing 68/69 and closes the connection between the second and third connections 62, 63. The preload element 54 is in particular arranged in a chamber formed in the region of the third connection 63. FIG. 2 thus shows the control piston 52 and the preload element 54 in their basic positions (control piston 52: normal traverse position, preload element 54: locking position).

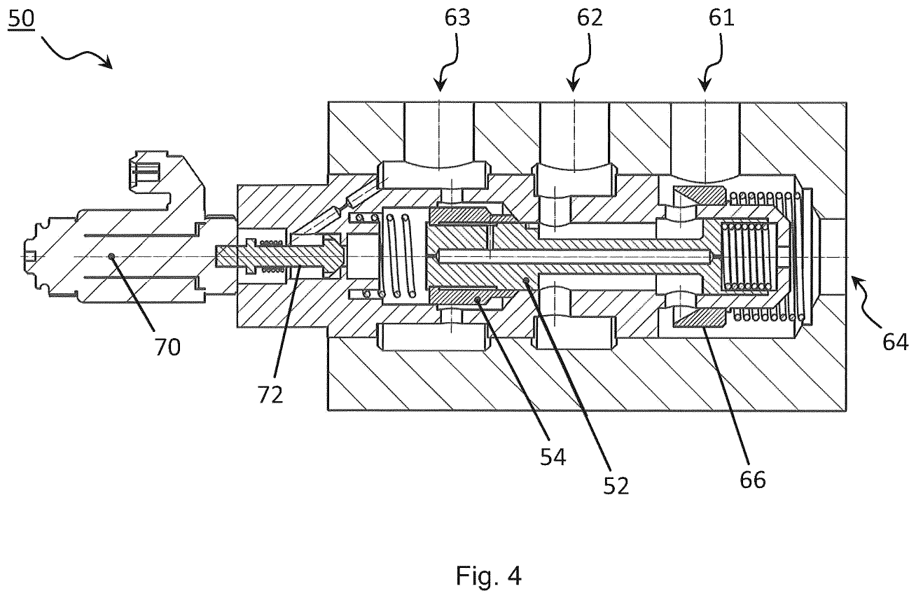

Furthermore, the valve unit 50 can comprise a non-return valve 66 having a valve body that annularly surrounds the control piston 52, and a spring that preloads the valve body into a locking position (cf. FIG. 2). In the locking position, the valve body closes a connection between the first and second connections 61, 62. The valve body can comprise a control surface that is chamfered towards the control piston 52, which surface is configured such that the non-return valve 66 opens (see FIG. 4) upon application of pressure from the side of the second connection 62 (when the pressure is greater than the pressure prevailing at the first connection 61) and thereby interconnects the first and second connections 61, 62.

In the embodiment of FIGS. 2-5, the sleeve 69 mounted in the valve housing 68 can comprise an end portion in the region of the first connection 61, within which end portion the control piston 52 is supported via the first spring 53 on the end portion, while the non-return valve 66 is arranged in a chamber 84 formed between the end portion of the sleeve 69 and the valve housing 68, which chamber can be connected to the fourth connection 64 (cf. FIG. 2), and surrounds the end portion. The end portion can end at a distance in front of the fourth connection 64, formed at the end face in the valve housing 68, in order that there is always a hydraulic connection between the first and fourth connections 61, 64. However, other embodiments are also conceivable.

The control piston 52 can comprise a drilled hole 56 or a channel 56 which extends axially, in particular coaxially with the longitudinal axis thereof, within the control piston 52 from an end face facing towards the first spring 53 at least to the region of the preload element 54. There, the channel 56 is connected via a radial drilled hole 57 to an annular chamber 58 (see FIG. 3) which is formed between the control piston 52 and the sleeve-shaped preload element 54. Towards the left-hand side (=the side facing away from the first spring 53) the annular chamber 58 is limited by an annular control surface of the preload element 54, such that the preload element 54 is displaced to the left into an open position (see FIG. 3) counter to the preload force of the second spring 55 by pressure application of the annular chamber 58 via the channel 56, 57. As a result, the connection between the second and third connections 62, 63 opens (cf. FIG. 3).

The preload element 54 can comprise a chamfered control surface 74 on the outside in the region of the third connection 63, which control surface is configured such that the preload element 54 is displaced to the left, into the open position, by pressure application via the third connection 63. Thus, the preload element 54 can be displaced into the open position both in the case of pressure application of the third connection 63 and in the case of pressure application of the first connection 61 (via the channel 56). Consequently, the preload means of the valve unit 50 always opens when pressure is applied via the hydraulic pump 12 to one of the pressure chambers 21, 22 for active retraction or extension of the hydraulic cylinder 20.

However, the preload element 54 is configured such that it remains in the locking position (FIGS. 2 and 4) when there is pressure application only via the second connection 62. As a result, undesired extension of the hydraulic cylinder 20 in the case of a pressure increase in the annular chamber 22 is prevented, while during regular retraction and extension of the hydraulic cylinder 20 the preload means is “inactive”.

The valve unit 50 further comprises an actuation unit 70 which presses the control piston 52 from the normal traverse position (cf. FIG. 2) into a rapid traverse position (cf. FIG. 4) upon actuation, and thereby interconnects the first and second connections 61, 62 or the two pressure chambers 21, 22. The actuation unit 70 may be a solenoid valve which, when energised, actuates a valve piston 72 mounted axially to the control piston 52 (cf. FIG. 2) and presses said valve piston against a valve seat (cf. FIG. 4), which leads, on account of a pressure buildup via the channel 56 in a chamber that is now closed by the valve piston 72 and is fluidically connected to the third connection 63, to a displacement of the control piston 52 into the rapid traverse position.

The channel 56 can optionally extend as far as the other, solenoid valve-side end of the control piston 52, and can lead, there, optionally via a throttle, into a space which is connected to the mentioned chamber 73 that can be closed by the valve piston 72. The connection between the chamber 73 and the third connection 63 can likewise comprise a throttle. On account of the throttles, a pressure can build up and reduce in the space between the chamber 73 and the control piston 52. Furthermore, the throttles limit the switching speed.

The valve unit 50 integrates a rapid traverse function and a preload function for the hydraulic cylinder in a compact manner, and can have the following mode of operation:

In the unactuated state (cf. FIGS. 2-3), the control piston 52 is in the normal traverse position. In said normal traverse mode, a regular retraction and extension of the hydraulic cylinder 20 can take place, in which the hydraulic oil, displaced in each case from one of the pressure chambers 21, 22, flows out via the control valve 14 into the hydraulic tank 14. In this case, depending on the pressure application, the preload element 54 can be in the locking position (cf. FIG. 2) or in the open position (cf. FIG. 3).

Upon actuation of the actuation unit 70, the control piston 52 is pressed into the rapid traverse position (cf. FIG. 4) in which a connection between the second and third connections 62, 63 is separated by a control edge of the control piston 52, and in the case of a pressure application at the first connection 61 the first and second connections 61, 62 are interconnected for the rapid traverse mode.

Due to the switching into the rapid traverse mode, the ratio of the piston surface to rod surface of the hydraulic cylinder 20 increases accordingly, with the same load of the operating pressure. Upon switching back into the normal traverse mode, this pressure must be reduced again. In order that this does not lead to a pressure release shock in the case of a telescopic cylinder, which would load the support structure of the mobile crane, at least one control notch 80 can be formed on the control piston 52 (see FIG. 3). The control notch(es) 80 can be configured as axially milled-in grooves or also radially applied bevels, and is/are located in particular in the region of the control edge which closes the connection between the second and third connection 62, 63 in the rapid traverse position. The number of control notches 80 can be determined by the necessary overall opening cross-section. The at least one control notch 80 allows for a slowed pressure reduction, while the control piston 52 moves back into the normal traverse position, and prevents a depressurisation shock which would be disturbing and loading.

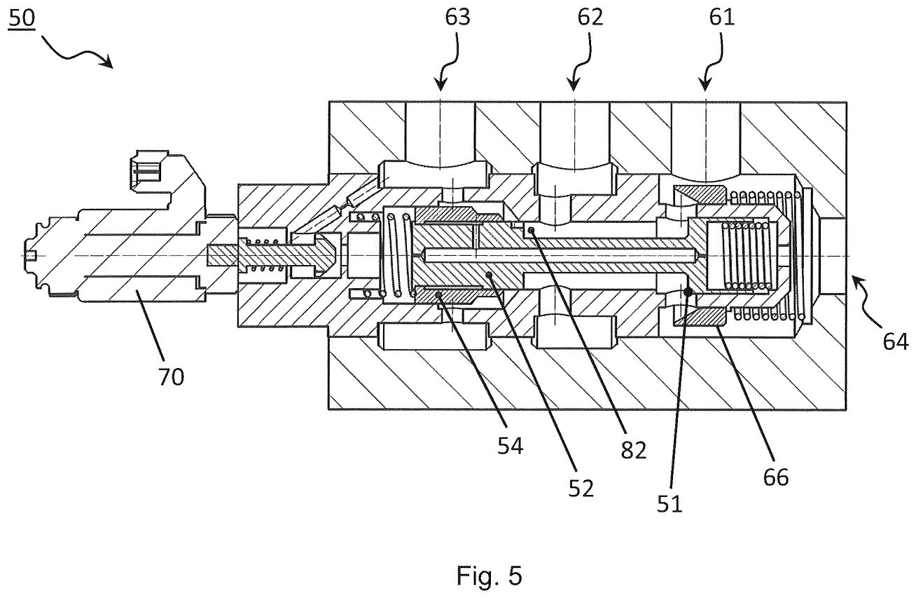

FIG. 5 shows the control piston 52 during the switching back into the normal traverse position. In this case, an opening 82 has formed in the region of the control notch 80, which opening connects the second and third connections 62, 63.

In the case of a telescopic cylinder, the telescopic payload is smaller in rapid traverse than in normal traverse. Depending on the current payload, telescopic boom angle and telescope length, it may be possible and expedient to switch into rapid traverse mode, or not. The crane operator would have to make this decision with the aid of payload tables, which would represent a significant diversion from the crane operation. Therefore, the switching between rapid and normal traverse mode may take place automatically by a control unit of the hydraulic system 10 (not shown).

In one embodiment, the current load is determined by a pressure measurement by the two pressure sensors 33 and 34. A maximum possible load is known from a payload table stored in a memory unit. By calculating in advance the working pressures in the piston chamber 21 and in the annular chamber 22, by the control unit, in each case before or after switching from rapid traverse to normal traverse or vice versa, this can decide whether switching is actually possible or not, and accordingly switch or indeed not. The crane operator is not burdened with this decision and distracted thereby, but rather can concentrate on the handling of the load and nonetheless always achieves the quickest telescoping time in the respective situation.

The valve unit 50 can optionally be configured as a valve cartridge. As a result, external piping can be avoided and a direct oil flow without line losses can be achieved. Furthermore, the valve cartridge can be placed directly in the hydraulic cylinder 20, which is space-saving.

FIGS. 2-5 are shown approximately to scale. FIGS. 2-5 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

### LIST OF REFERENCE SIGNS

1 first actuator
2 second actuator
3, 4 valves
5-7 supply lines
10 hydraulic system
11 hydraulic tank
12 hydraulic pump
14 control valve
15 pre-control valve
16 lowering brake valve
20 hydraulic cylinder
21 first pressure chamber
22 second pressure chamber
23 piston rod
24 piston
25 outer feedthrough pipe
26 inner feedthrough pipe
27 cylinder housing
31-34 pressure sensors
41 pressure limiting valve
42 pressure balance
43-47 pressure limiting valves
50 valve unit
51 control edge
52 shift piston
53 first preload device
54 preload element
55 second preload device
56 channel
57 radial drilled hole
58 annular chamber
61 first connection
62 second connection
63 third connection
64 fourth connection
66 non-return valve
68 valve housing
69 sleeve
70 actuation unit
72 valve piston
73 chamber
74 control surface
75 valve surface
76 valve seat
80 control notch
82 opening
84 chamber

1. A hydraulic system for pressure supply of a hydraulic actuator, comprising a double-acting hydraulic cylinder having a first and second pressure chamber to which pressure can be applied via a hydraulic pump, and a rapid traverse device which is configured to hydraulically interconnect the two pressure chambers in a rapid traverse mode, such that hydraulic fluid displaced out of one pressure chamber can flow into the other pressure chamber, and to hydraulically separate the two pressure chambers from one another in a normal traverse mode,
wherein
the rapid traverse device is integrated into a valve unit of the hydraulic system, which valve unit is connected to the two pressure chambers via a first and second connection and comprises a third connection to which pressure can be applied via the hydraulic pump, wherein the valve unit comprises a displaceably mounted shift piston which hydraulically separates the first and second connections from one another in a normal traverse position and in a rapid traverse position hydraulically interconnects the first and second connections and separates them from the third connection, wherein furthermore a preload means having a switchable preload element is integrated into the valve unit, which preload element is configured to separate the third connection from the second connection in a locking position and thereby to lock the pressure chamber connected to the second connection towards the outside.

2. The hydraulic system according to claim 1, wherein the valve unit comprises an actuation unit, by means of which the shift piston is movable between the normal traverse position and the rapid traverse position, wherein the shift piston is preloaded into the normal traverse position via a first preload device and is movable into the rapid traverse position by means of the actuation unit.

3. The hydraulic system according to claim 1, wherein the preload element is configured as a sleeve which surrounds the shift piston and is mounted so as to be displaceable relative thereto.

4. The hydraulic system according to claim 3, wherein the shift piston has a channel extending along its displacement direction, which channel is guided radially towards the outside in the region of the sleeve and leads into an annular chamber formed between the shift piston and sleeve.

5. The hydraulic system according to claim 1, wherein the preload element is preloaded into the locking position by a second preload device and is movable into an open position by pressure application of the first or of the third connection in the normal traverse mode, in which open position the second and third connections are hydraulically connected.

6. The hydraulic system according to claim 1, wherein the valve unit comprises a non-return valve which is arranged between the first and second connections and is configured, in the rapid traverse position of the shift piston, to release a flow of hydraulic fluid from the second to the first connection and to block a flow of hydraulic fluid from the first to the second connection.

7. The hydraulic system according to claim 1, comprising a control valve for retracting and extending the hydraulic cylinder, which valve has a first intake connected to the hydraulic pump, a second intake connected to a hydraulic tank, and two outlets connected to the pressure chambers of the hydraulic cylinder, wherein one of the outlets is connected to the first connection of the valve unit and/or one of the outlets is connected to the third connection of the valve unit.

8. The hydraulic system according to claim 1, comprising a control unit by means of which an actuation unit moving the shift piston can be controlled for switching between rapid traverse and normal traverse mode, wherein the control unit is configured to determine a load of the hydraulic cylinder depending at least on a pressure measurement in the hydraulic system and to compare this with at least one stored characteristic value, wherein the control unit is further configured to determine a load resulting in the future due to switching, before the switching from rapid traverse to normal traverse mode, or vice versa, to compare this with at least one stored characteristic value, and to decide, on the basis of the comparison, whether or not switching can take place.

9. The hydraulic system according to claim 1, comprising a lowering brake valve which is arranged between the valve unit and one of the pressure chambers, wherein the lowering brake valve blocks a return flow of hydraulic fluid out of the pressure chamber in a first switching position and releases a flow of hydraulic fluid into the pressure chamberby means of an integrated non-return valve, and wherein the lowering brake valve allows a return flow of hydraulic fluid out of the pressure chamber in a second switching position.

10. The hydraulic system according to claim 1, wherein the hydraulic cylinder comprises a piston and a piston rod having a pipe feedthrough, wherein a pressure supply of the hydraulic actuator takes place via the pipe feedthrough, wherein the piston rod is guided out of a cylinder housing of the hydraulic cylinder on one side, and wherein an annular chamber formed on the side of the piston rod is connected to the second connection and a piston chamber formed on the opposite side of the piston is connected to the first connection of the valve unit.

11. The hydraulic system according to claim 1, wherein the hydraulic cylinder is a telescopic cylinder and the hydraulic system comprises a locking device connected to the telescopic cylinder for reversibly locking the telescopic cylinder to a telescopic section and/or for reversibly locking two telescopic sections of a telescopic boom, wherein at least one hydraulic actuator of the locking device can be supplied with pressure via the hydraulic system.

12. The hydraulic system according to claim 1, wherein the components of the rapid traverse device and the preload means are arranged in a common housing of the valve unit, and/or wherein the valve unit is configured as a valve cartridge and is arranged inside a cylinder housing of the hydraulic cylinder.

13. A valve unit comprising an integrated rapid traverse device and an integrated preload means of a hydraulic system according to claim 1.

14. A work tool, comprising a hydraulic system according to claim 1, wherein the work tool is a mobile crane.

15. The work tool according to claim 14, configured as a mobile crane having a telescopic boom, wherein the telescopic boom comprises an outer telescopic section, at least one inner telescopic section that is displaceably mounted therein, a hydraulic telescopic cylinder for retracting and extending the at least one inner telescopic section, and a locking device that is connected to the telescopic cylinder for reversibly locking the telescopic cylinder to an inner telescopic section and/or for locking two telescopic sections together, wherein at least one actuator of the locking device can be supplied with pressure via the hydraulic system.

16. The hydraulic system according to claim 2, wherein the actuation unit is electrically controllable.

17. The hydraulic system according to claim 2, wherein the actuation unit is a solenoid valve.

18. The hydraulic system according to claim 3, wherein the sleeve is arranged in a region of the third connection.

19. The hydraulic system according to claim 4, wherein an opening of the channel is arranged in the shift piston in a region of the first connection, such that the annular chamber is hydraulically connected to the first connection irrespective of a position of the shift piston.

20. The hydraulic system according to claim 6, wherein the non-return valve comprises a valve body that annularly surrounds the shift piston and is mounted so as to be displaceable relative thereto.
